(19) United States
(12) Patent Application Publication
(10) Pub. No.: US 2019/0310933 A1
(43) Pub. Date: Oct. 10, 2019

(54) EXTERNALIZED DEFINITION AND REUSE OF MOCKED TRANSACTIONS

(71) Applicant: CA, Inc., Islandia, NY (US)

(72) Inventors: Robert Williams, Howe, TX (US); Stephen J. Tyler, McKinney, TX (US)

(73) Assignee: CA, Inc., Islandia, NY (US)

(21) Appl. No.: 15/950,128

(22) Filed: Apr. 10, 2018

(51) Int. Cl. G06F 11/36

(52) U.S. Cl. CPC G06F 11/3688; G06F 8/41

(57) ABSTRACT

Aspects of the embodiments include a system, method, and computer program operations, including compiling unit test code by a compiler run on a hardware computing system; identifying in the unit test code a call for a mocked transaction based on a name of the mocked transaction within the unit test code; identifying a location of the mocked transaction in a mocked transaction repository, the mocked transaction repository comprising mocked transaction code associated with the mocked transaction; executing the mocked transaction code associated with the mocked transaction; and outputting a response to the mocked transaction based at least in part on the unit test code

### FIELD

This disclosure pertains to the externalized definitions and reuse of mocked transactions.

### BACKGROUND

In computer programming, unit testing is a software testing method by which individual units of source code, sets of one or more computer program modules together with associated control data, usage procedures, and operating procedures, are tested to determine whether they are fit for use. Mocking is can be used in unit testing. An object under test may have dependencies on other (complex) objects. To isolate the behavior of the object under test one or more objects can be replaced by mocks that simulate the behavior of the real objects. Mocking is used to create objects that simulate the behavior of real objects.

### SUMMARY

Aspects of the embodiments are directed to computer implemented method that can include compiling unit test code by a compiler run on a hardware computing system; identifying in the unit test code a call for a mocked transaction based on a name and definition of the mocked transaction within the unit test code; executing mocked transaction code associated with the mocked transaction; and outputting a response to the mocked transaction based at least in part on the unit test code.

Aspects of the embodiments are directed to a non-transitory computer-readable medium having program instructions stored therein, wherein the program instructions are executable by a computer system to perform operations that can include compiling unit test code by a compiler run on a hardware computing system; identifying in the unit test code a call for a mocked transaction that is named and defined in the unit test code; identifying a location of the mocked transaction, the mocked transaction repository comprising mocked transaction code associated with the mocked transaction; executing the mocked transaction code associated with the mocked transaction; and outputting a response to the mocked transaction based at least in part on the unit test code.

Aspects of the embodiments are directed to a system that can include a hardware processor; and a memory coupled to the hardware processor, the memory for storing data. The hardware processor to compile unit test code by a compiler run on a hardware computing system; identify in the unit test code a call for a mocked transaction that is defined and named within the unit test code; identify a location of the mocked transaction in a mocked transaction repository, the mocked transaction repository comprising mocked transaction code associated with the mocked transaction; execute the mocked transaction code associated with the mocked transaction; and output a response to the mocked transaction based at least in part on the unit test code.

In some embodiments, identifying the location of the mocked transaction comprises identifying a mocked transaction code for the mocked transaction contained in a file system.

In some embodiments, the mocked transaction repository resides on one of a file server, a remote database, or a web service.

Some embodiments can include identifying in the unit test the call for the mocked transaction based on a tag.

In some embodiments, the name of the mocked transaction comprises a semantic name that identifies a function of the mocked transaction.

Some embodiments can include defining the mocked transaction into a domain-specific language (DSL) format; and storing the DSL-format mocked transaction in a repository accessible by a quality assurance center of excellence.

Some embodiments can include receiving from the quality assurance center of excellence one or more changes to the mocked transaction.

Some embodiments can include exporting the mocked transaction to a virtual service by converting the mocked transaction code into a format compatible with the virtual service and transmitting the converted mocked transaction code to a quality assurance system.

In some embodiments, identifying the location of the mocked transaction comprises identifying a mocked transaction that contains code for the mocked transaction contained in a file system.

In some embodiments, the mocked transaction repository resides on one of a file server, a remote database, or a web service.

Some embodiments can include identifying in the unit test the call for the mocked transaction based on a tag.

In some embodiments, the name of the mocked transaction comprises a semantic name that identifies a function of the mocked transaction.

Some embodiments can include defining the mocked transaction into a domain-specific language (DSL) format; and storing the DSL-format mocked transaction in a repository accessible by a quality assurance center of excellence.

Some embodiments can include exporting the mocked transaction code to a virtual service receiving from the quality assurance center of excellence one or more changes to the mocked transaction.

Some embodiments can include exporting the mocked transaction to a virtual service comprises converting the mocked transaction code into a format compatible with the virtual service and transmitting the converted mocked transaction code to a quality assurance system.

In some embodiments, the processor is to identify the location of the mocked transaction by identifying a mocked transaction repository within the memory that contains code for the mocked transaction.

In some embodiments, the memory comprises one of a local file system, file server, a remote database, or a web service, and the mocked transaction repository resides on one of the file server, the remote database, or the web service.

In some embodiments, the processor is to identify in the unit test the call for the mocked transaction based on a name of the mocked transaction comprises identifying the name of the mocked transaction based on a domain-specific language (DSL) name.

### BRIEF DESCRIPTION OF THE DRAWINGS

FIGS. 1A-B are schematic diagrams of a computing system for externalized definitions and reuse of mocked transactions.

FIG. 2 is a process flow diagram for providing a mocked transaction name in a unit test in accordance with embodiments of the present disclosure.

FIG. 3 is a process flow diagram for exporting a mocked transaction for a virtual service in accordance with embodiments of the present disclosure.

FIG. 4 is a schematic block diagram of a computing system in accordance with embodiments of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language, such as JAVA, SCALA, SMALLTALK, EIFFEL, JADE, EMERALD, C++, C#, VB.NET, PYTHON, Groovy or the like, conventional procedural programming languages, such as the “C” programming language, VISUAL BASIC, FORTRAN 2003, Perl, COBOL 2002, PHP, ABAP, dynamic programming languages such as PYTHON, RUBY and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a,” “an,” and “the” are intended to comprise the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The use of mocks in unit tests can be a useful way of simulating transactions. There are several issues that surface when using mocks in unit tests. For example, defining mocks in unit test code can be verbose, making it hard to understand tests and making it hard to find and reuse mocks. To address this problem, among others, this disclosure describes naming mocked transactions in code to replace verbose mocks integrated within the unit test code.

Another issue that can arise in unit testing using mocked transactions is that unit tests do not verify that the code is robust (e.g., can be effective for transactions other than what the developer intended). The reason for this can be due to a lack of quality assurance (QA) involvement during development and/or unit testing. This disclosure can address the aforementioned problem by defining mocked transactions in locations or systems (e.g., filesystem, database, web service) and in formats (plain-text domain specific languages) that are accessible to QA; and also using tags to refer to metatdata for the mocked transactions, such as an appropriate context or test case in which the transaction will be used. QA can also use data-driven testing (JUnit theories, Spock, etc.) to iterate over the responses. The features described herein allow QA to add/update mocked transactions to cover cases that the developer may have missed. In addition, these mocked transactions can be executed as part of compilation/continuous integration (CI) rather than later in the pipeline, so bugs are easier to find and fix.

Another issue that can be encountered when using mocked transactions in unit tests is that unit test assets (e.g., mocks) are not reusable in downstream testing. This disclosure addresses this issue by providing a mechanism whereby mocked transaction definitions can be used to compose a virtual service. By example, a mock may run only for duration of test. A virtual service, however, can be long-running, and not tied to context of a unit test.

Mocked transactions can have a different style of matching than a virtual service. This disclosure describes providing QA Center of Excellence (CoE) with a textual description (e.g., domain-specific language (DSL)) of the mock, as well as metadata (e.g., tags, name, etc.), and an actual request and response encountered during execution of the mocked transaction.

Aspects of the embodiments described herein are directed to the naming and externalization (in a human-friendly domain-specific language (DSL)) of mocked transactions typically run via JUnit or similar tools, to improve comprehension and reuse. The information and tooling can be provided to allow quality assurance to collaborate with developers by contributing to the suite of mocked transactions, which can be automatically run early in the CI process, and to add those transactions to downstream testing asserts such as a virtual case.

Aspects of this disclosure pertain to mechanisms to name mocked transactions, externalize the definitions in a human-friendly DSL, allow QA to contribute transactions into the compilation/CI pipeline, and allow QA to consume unit test information for downstream use. The features described herein allow for the expansion of collaboration across developers and between developers and QA.

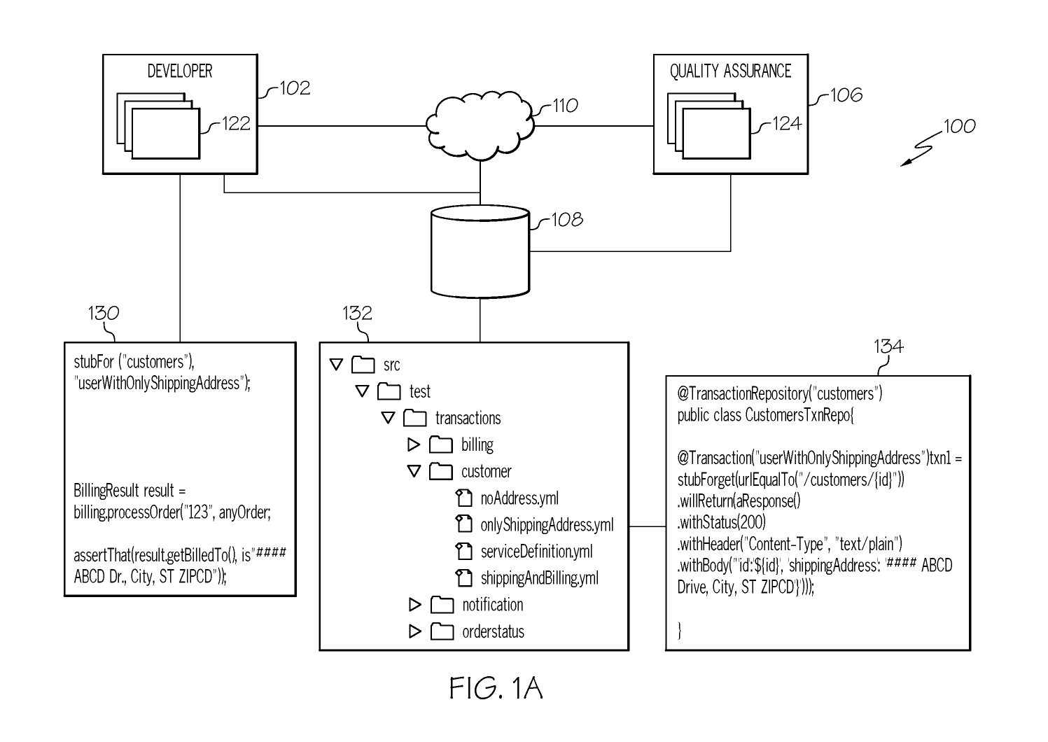

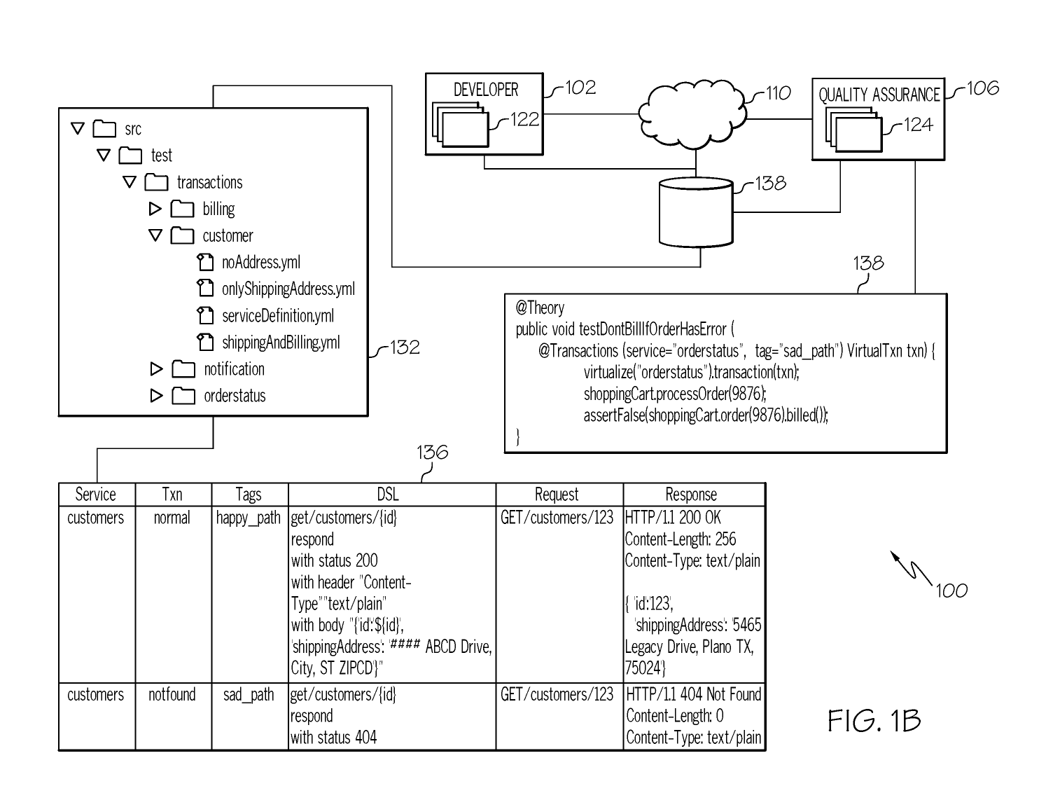

FIG. 1A is a schematic diagram of a computing system 100 for development and quality assurance of unit test code in accordance with embodiments of the present disclosure. The computing system 100 can include a developer system and a quality assurance (QA) system, though it is understood that a developer system and a QA system can be the same system, disparate systems located proximate to each other, disparate system located remotely from each other, etc. The computing system 100 includes one or more developer computing systems 102. The developer computing system 102 can include one or more hardware processors 122. The developer computing system 102 can include a user interface to allow a developer to write and edit unit test code and mocked transactions 130. The developer includes a mocked transaction as a named call to mocked transaction code 134 that is stored elsewhere. The mocked transaction name is a semantic name that helps anyone parsing the code to understand what the mocked transaction code 134 is meant to do. In the example of FIG. 1A, the mocked transaction is “userWithOnlyShippingAddress,” which implies that a user has the same billing and shipping addresses. In embodiments, the call to the mocked transaction can also include an identification of where the mocked transaction code 134 is located.

In the example shown in FIG. 1A, the mocked transaction code 132 resides in repository 132 in a folder named “customer.” The term “repository” in this context refers to any file system that facilitates residency of the code, including flat files, other parts of the unit test, databases, web services, etc. The repository 130 can be a file system, web service, database, etc. In embodiments, the developer can create mocked transaction code, which the developer can store in a repository 132 stored in memory 108. The memory 108 can be a local memory to the developer computing system 102. The memory 108 could also be a remote storage system accessible through a network 110. The mocked transaction can be referenced by name within the unit test code 130, as opposed to the developer adding the entirety of the mocked transaction code within the unit test code.

When a mocked transaction is run within the unit test code, a response to a set of parameters can be provided. In embodiments, responses to mocked transactions can also be organized separately from the unit test code. One organizational structure for these responses can include using tags to generalize certain responses, and associate those responses with tags that are included in the mocked transaction.

FIG. 1B is a schematic diagram of a computing system 100 for development and quality assurance of unit test code in accordance with embodiments of the present disclosure. FIG. 1B illustrates the quality assurance (QA) computing system 106. The QA computing system can represent computing devices and resources used by QA engineers to perform quality assurance of work product produced by a developer. The QA computing system 106 can include one or more hardware processors 124. In some embodiments, the developer system 102 can externalize (or export) mocked transactions in a domain-specific language (DSL) to an external repository 140. External repository 140 can include a network storage device accessible by the QA system 106. The QA system 106 can access mocked transactions in a QA-friendly format for testing.

The QA computing system 106 can include a user interface for performing quality assurance of unit test code, which can include using data-driven testing (e.g., JUnit theories, Spock, etc.) to iterate over the responses to the mocked transactions in the unit test code. The QA can evaluate the unit test code and mocked transactions as part of the compilation/continuous integration (CI) rather than later in the pipeline, so that bugs are easier to find and fix.

The QA-side can add/update other mocked transactions to cover cases that the developer may have missed. The QA can add or edit responses to mocked transactions, including happy paths, sad paths, and other responses/response types. The QA can provide these additions or edits to the repository 132.

As an example, the QA can add “sad path” cases that the developer may have missed. The developer can run a unit test many times with all mocked transactions tagged with a “sad path.” Such “sad path” responses can include 404 Not Found responses, 5xx errors, rate limit errors, or other types of errors, or transaction-specific responses, such as cancelled orders, back orders, delivery failures, delivery refusals, invalid billing information, etc. This example also highlights the use of tags to organize types of response cases. The mocked transaction can be executed using each response case for a particular tag. In this example, the tag is “sad path” and can refer to multiple response scenarios, as mentioned above.

The QA system can augment the DSL-formatted mocked transaction with the additional response cases. For example, the QA can add the additional response cases under the appropriate tag or tags, such as the “sad path” example above. These additions automatically become part of the available responses for the mocked transaction that includes the tag.

In some embodiments, the QA system can create virtual services based on mocked transactions definitions. Mocked transactions run in a different context than a virtual service. For example, a mocked transaction runs only for duration of test; while a virtual service can be long-running, and not tied to context of a unit test. In addition, mocked transactions have a different style of matching than a virtual service. To resolve the disparities between the mocked transactions and the virtual service, the QA system can be provided by the developer or by another service with a textual description (e.g., DSL) of the mocked transaction, metadata (tags, name), and/or an actual request and response encountered during execution. If the mocked transaction is defined in code, then the textual description can be automatically generated by the mocking tool and provided to the QA system. If the mock is defined in a database or the filesystem, then the definition is itself the DSL textual description. The textual description, metadata, and request/response information can be included in the data structure 136, which can exist as a long-lived virtual service to be used at a later date and for different purposes.

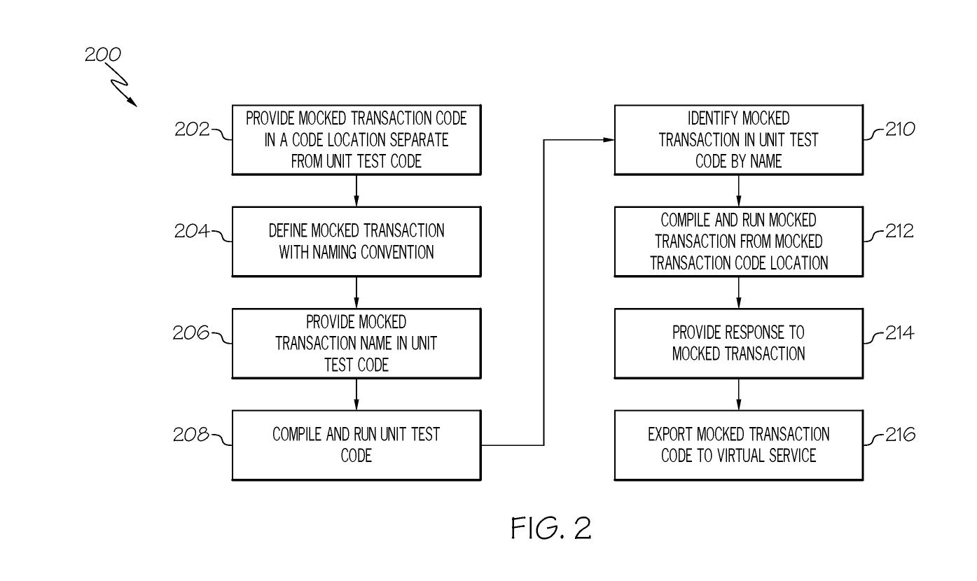

FIG. 2 is a process flow diagram 200 for providing a mocked transaction name in a unit test in accordance with embodiments of the present disclosure. A mocked transaction can be developed as part of a unit test and stored as code (202). The mocked transaction can be defined using a naming convention that indicates the type of mocked transaction, along with other identifying characteristics of the mocked transaction, such as the location in the repository, etc. (204). The mocked transaction can also include a tag that identifies a response type for organizing response cases for the unit test to run through iteratively. The mocked transaction can be called for in a unit test by the developer by the naming convention (206). The unit test can be compiled and run as part of a developer test or execution cycle (208). During the execution of the unit test, the mocked transaction can be identified by the naming convention (210). The mocked transaction can be executed from the repository or the coding can be retrieved and run locally (212). A response to the mocked transaction can be provided (214). In certain embodiments, the mocked transaction can be exported to a quality assurance system (216).

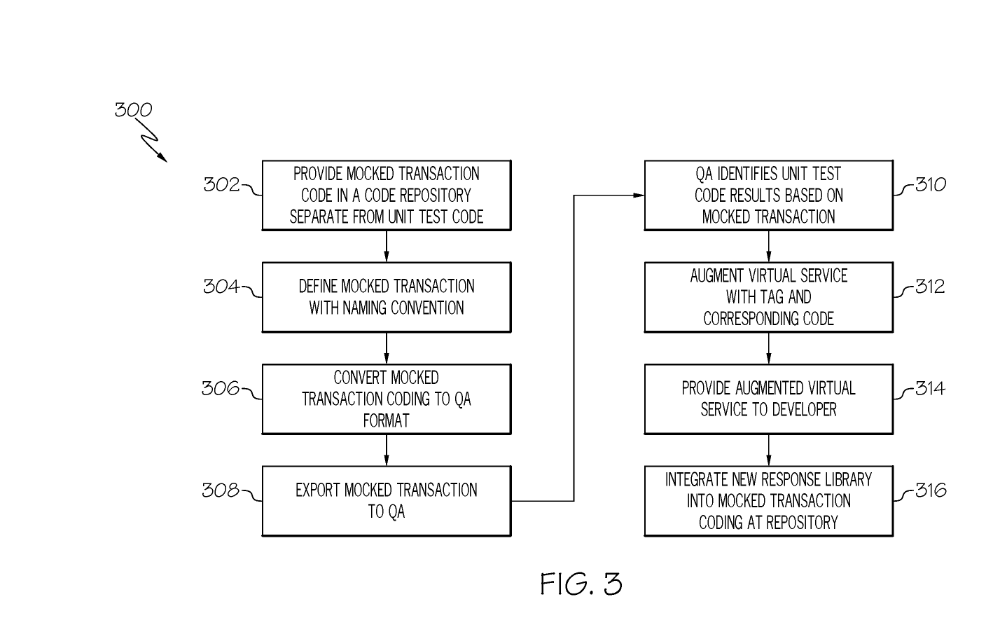

FIG. 3 is a process flow diagram 300 for exporting a mocked transaction for a virtual service in accordance with embodiments of the present disclosure. A mocked transaction can be developed as part of a unit test and stored as code in a repository (302). The mocked transaction can be defined using a naming convention that indicates the type of mocked transaction, along with other identifying characteristics of the mocked transaction, such as the location in the repository, etc. (304). The mocked transaction coding can be converted into a quality assurance (QA) compatible format and stored in a repository that is accessible to the QA system, such as in a database, web service, or other file service (306). The mocked transaction can then be exported to the QA system for further scrutiny (308).

The QA system can identify a unit test code result(s) based on the mocked transaction (310 The QA can augment the mocked transaction definitions in the repository with one or more additional responses that can be associated with a tag, such as with happy paths, sad paths, and other responses/response types that are not present in the current mocked transaction response library (312). The augmented definitions of the mocked transaction responses can be used by the developer. The QA can store the mocked transaction definition as a virtual service (314). The QA can augment the can then integrate the new response library into the repository with the mocked transaction coding (316).

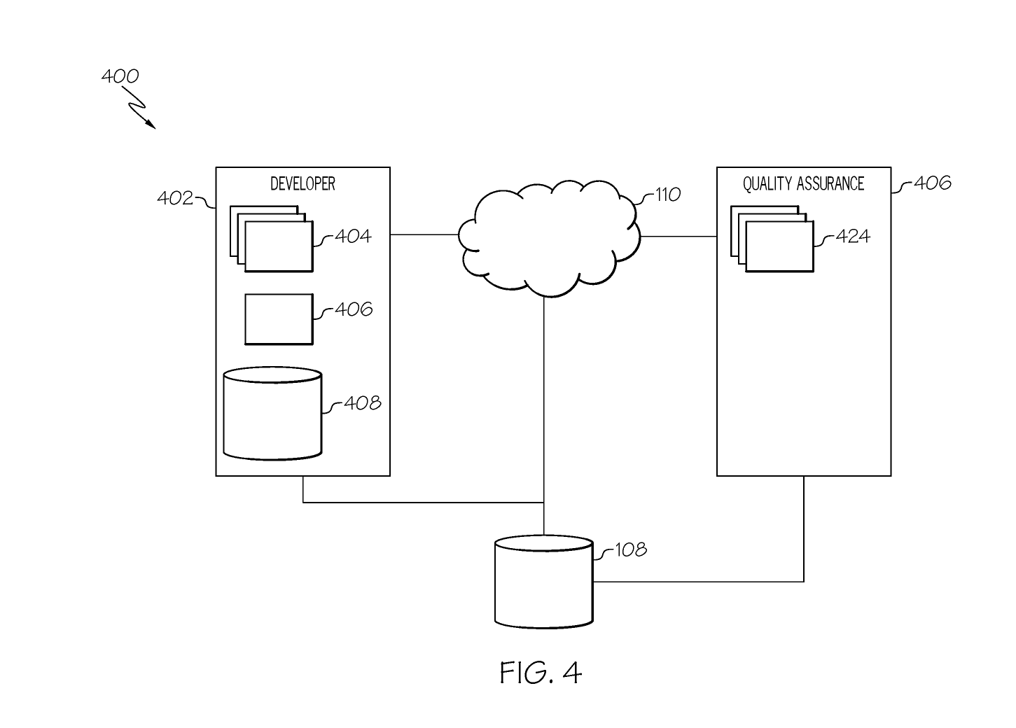

FIG. 4 is a schematic block diagram of a computing system 400 in accordance with embodiments of the present disclosure. The system 400 can be a software development system, such as those described above with FIGS. 1A-B. The system 400 can include a developer platform 402 that can include one or more computer processors 404. The computer processors 404 can be hardware computer processors that can implement software algorithms. the computer processors 404 can be local processors or a distributed processor bank, such as in a workstation environment. The developer platform 402 can also include an interface 406 for development of computer programs. The interface 406 can allow a developer to create, edit, compile, run, debug, etc., computer code. The interface 406 can also allow the developer to access local and remote data storage systems, such as local storage 408 and remote storage 108. The developer platform 402 can access remote storage 108, as well as other remote locations, across a network 110, which can be a wired or wireless network, such as a local area network, a wide area network, the Internet, or other network.

The developer platform 402 can include a local hardware storage 408, that can be a hard drive or other storage device, such as a flash memory. The developer can store code onto the local hardware storage 408. The developer can also storage code onto the remote storage 108. Such code can include code that includes named mocked transactions, whether within a larger piece of coding, or as a separate file.

The computing system 400 can also include a quality assurance (QA) platform 420. The QA platform 420 can be a computer platform separate from the developer platform 402, or can be a subsystem that is part of the developer platform 402. The QA platform can include one or more hardware processors 424. The QA platform can also include a QA interface 426 for interfacing with the developer platform 402 to access and augment mocked transaction code, as described above. The QA platform 402 can also include an interface 428 for generating virtual services based on one or more mocked transactions, as described above. The QA platform can access remote storage 108 across an network 110, to access, augment, or otherwise interface with mocked transactions that are created by the developer platform 402 and stored in a storage system associated with the developer platform 402, such as remote storage 108.

The figures illustrate the architecture, functionality, and operation of possible implementations of systems, methods, and computer program products according to various aspects of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

While the present disclosure has been described in connection with preferred embodiments, it will be understood by those of ordinary skill in the art that other variations and modifications of the preferred embodiments described above may be made without departing from the scope of the disclosure. Other embodiments will be apparent to those of ordinary skill in the art from a consideration of the specification or practice of the disclosure disclosed herein. It will also be understood by those of ordinary skill in the art that the scope of the disclosure is not limited to use in a server diagnostic context, but rather that embodiments of the disclosure may be used in any transaction having a need to monitor information of any type. The specification and the described examples are considered as exemplary only, with the true scope and spirit of the disclosure indicated by the following claims.

As indicated above, the network entities that make up the network that is being managed by the network management system are represented by software models in the virtual network machine. The models represent network devices such as printed circuit boards, printed circuit board racks, bridges, routers, hubs, cables and the like. The models also represent locations or topologies. Location models represent the parts of a network geographically associated with a building, country, floor, panel, rack, region, room, section, sector, site or the world. Topological models represent the network devices that are topologically associated with a local area network or subnetwork. Models can also represent components of network devices such as individual printed circuit boards, ports and the like. In addition, models can represent software applications such as data relay, network monitor, terminal server and end point operations. In general, models can represent any network entity that is of interest in connection with managing or monitoring the network.

The virtual network machine includes a collection of models which represent the various network entities. The models themselves are collections of C++ objects. The virtual network machine also includes model relations which define the interrelationships between the various models. Several types of relations can be specified. A “connects to” relation is used to specify an interconnection between network devices. For example, the interconnection between two workstations is specified by a “connects to” relation. A “contains” relation is used to specify a network entity that is contained within another network entity. Thus for example, a workstation model may be contained in a room, building or local network model. An “executes” relation is used to specify the relation between a software application and the network device on which it runs. An “is part of” relation specifies the relation between a network device and its components. For example, a port model may be part of a board model or a card rack model.

What is claimed is:

1. A computer implemented method comprising:
compiling unit test code by a compiler run on a hardware computing system;
identifying in the unit test code a call for a mocked transaction based on a name and definition of the mocked transaction within the unit test code;
executing mocked transaction code associated with the mocked transaction; and
outputting a response to the mocked transaction based at least in part on the unit test code.

2. The computer implemented method of claim 1, wherein identifying the location of the mocked transaction comprises identifying a mocked transaction code for the mocked transaction contained in a file system.

3. The computer implemented method of claim 2, wherein the mocked transaction repository resides on one of a file server, a remote database, or a web service.

4. The computer implemented method of claim 1, further comprising identifying in the unit test the call for the mocked transaction based on a tag.

5. The computer implemented method of claim 1, wherein the name of the mocked transaction comprises a semantic name that identifies a function of the mocked transaction.

6. The computer implemented method of claim 1, further comprising defining the mocked transaction into a domain-specific language (DSL) format; and storing the DSL-format mocked transaction in a repository accessible by a quality assurance center of excellence.

7. The computer implemented method of claim 6, further comprising receiving from the quality assurance center of excellence one or more changes to the mocked transaction.

8. The computer implemented method of claim 1, further comprising exporting the mocked transaction to a virtual service by converting the mocked transaction code into a format compatible with the virtual service and transmitting the converted mocked transaction code to a quality assurance system.

9. A non-transitory computer-readable medium having program instructions stored therein, wherein the program instructions are executable by a computer system to perform operations comprising:
compiling unit test code by a compiler run on a hardware computing system;
identifying in the unit test code a call for a mocked transaction that is named and defined in the unit test code;
identifying a location of the mocked transaction, the mocked transaction repository comprising mocked transaction code associated with the mocked transaction;
executing the mocked transaction code associated with the mocked transaction; and
outputting a response to the mocked transaction based at least in part on the unit test code.

10. The non-transitory computer-readable medium of claim 9, wherein identifying the location of the mocked transaction comprises identifying a mocked transaction that contains code for the mocked transaction contained in a file system.

11. The non-transitory computer-readable medium of claim 10, wherein the mocked transaction repository resides on one of a file server, a remote database, or a web service.

12. The non-transitory computer-readable medium of claim 9, further comprising identifying in the unit test the call for the mocked transaction based on a tag.

13. The non-transitory computer-readable medium of claim 9, wherein the name of the mocked transaction comprises a semantic name that identifies a function of the mocked transaction.

14. The non-transitory computer-readable medium of claim 9, further comprising defining the mocked transaction into a domain-specific language (DSL) format; and storing the DSL-format mocked transaction in a repository accessible by a quality assurance center of excellence.

15. The non-transitory computer-readable medium of claim 9, further comprising exporting the mocked transaction code to a virtual service receiving from the quality assurance center of excellence one or more changes to the mocked transaction.

16. The non-transitory computer-readable medium of claim 15, further comprising exporting the mocked transaction to a virtual service comprises converting the mocked transaction code into a format compatible with the virtual service and transmitting the converted mocked transaction code to a quality assurance system.

17. A system comprising:
a hardware processor; and
a memory coupled to the hardware processor, the memory for storing data;
the hardware processor to:
compile unit test code by a compiler run on a hardware computing system;
identify in the unit test code a call for a mocked transaction that is defined and named within the unit test code;
identify a location of the mocked transaction in a mocked transaction repository, the mocked transaction repository comprising mocked transaction code associated with the mocked transaction;
execute the mocked transaction code associated with the mocked transaction; and
output a response to the mocked transaction based at least in part on the unit test code.

18. The system of claim 17, wherein the processor is to identify the location of the mocked transaction by identifying a mocked transaction repository within the memory that contains code for the mocked transaction.

19. The system of claim 18, wherein the memory comprises one of a local file system, file server, a remote database, or a web service, and the mocked transaction repository resides on one of the file server, the remote database, or the web service.

20. The system of claim 17, the processor is to identify in the unit test the call for the mocked transaction based on a name of the mocked transaction comprises identifying the name of the mocked transaction based on a domain-specific language (DSL) name.
